(19) United States
(12) Patent Application Publication
(10) Pub. No.: US 2026/0066843 A1
(43) Pub. Date: Mar. 5, 2026

(54) COVER ATTACHMENT STRUCTURE

(71) Applicants: Sunstack, LLC, Las Vegas, NV (US); ISM Holdings Group, Poway, CA (US)

(72) Inventor: Shuichi KOBAYASHI, Aichi (JP)

(21) Appl. No.: 19/319,826

(22) Filed: Sep. 5, 2025

(30) Foreign Application Priority Data
Sep. 5, 2024 (JP) 2024-153052

(51) Int. Cl. H02S 40/00

(52) U.S. Cl. CPC H02S 40/00

(57) ABSTRACT

A cover attachment structure partially covers a solar panel unit including a solar panel and a frame from outside with a cover. A cover receiving member receives, from below, the frame supporting the solar panel, with a receiving portion at an end thereof closer to inside with respect to an inside-outside direction. A cover hold down member holds down the frame from above with a hold down portion at an end thereof closer to the inside with respect to the inside-outside direction. The cover is attached to the solar panel unit with the cover receiving member and the cover hold down member. The cover hold down member is placed on the cover such that a length from the receiving portion to the hold down portion is adjustable.

### CROSS-REFERENCE TO RELATED APPLICATIONS

This application claims the benefit of Japanese Patent Application No. 2024-153052, filed on Sep. 5, 2024, the entire disclosure of which is incorporated by reference herein.

### FIELD OF THE INVENTION

This application relates to a cover attachment structure.

### BACKGROUND OF THE INVENTION

Japanese Patent No. 4383190 describes a decorative cover attachment structure for attachment of a decorative cover for a solar cell module that is to be attached to a panel frame of the solar cell module. The decorative cover attachment structure described in Japanese Patent No. 4383190 enables fixing the decorative cover even at a portion at which no mount is provided.

The decorative cover attachment structure of Japanese Patent No. 4383190 requires preparation of a component adjusted for a panel frame as a target of attachment, that is, requires different types of components for attachment of different types of panel frames as targets of attachment, and thus has a limitation in the shapes of panel frames to which this structure is attachable. Thus, with the decorative cover attachment structure disclosed in Japanese Patent No. 4383190, attachment of a cover to panel frames having various heights is unachievable.

The present disclosure is made in view of the aforementioned circumstances, and an objective of the present disclosure is to provide a cover attachment structure that enables attachment of a cover to frames of an installation target unit that have various heights.

### SUMMARY OF THE INVENTION

To achieve the aforementioned objective, a cover attachment structure according to the present disclosure is a cover attachment structure for partially covering, with a cover, from outside with respect to an inside-outside direction, an installation target unit including an installation target and a frame supporting the installation target, the cover attachment structure including:
a cover receiving member to receive, with a receiving portion included in the cover receiving member at an end thereof closer to inside with respect to the inside-outside direction, from below, the frame supporting the installation target;
a cover hold down member to hold down the frame from above with a hold down portion included in the cover hold down member at an end thereof closer to the inside with respect to the inside-outside direction;
the cover including a cover base and a cover body included in the cover base, the cover base being received by the cover receiving member from below and being held down from above by the cover hold down member, the cover being to be attached to the installation target unit with the cover receiving member and the cover hold down member; and
a first fastener to fix the cover receiving member and the cover hold down member to the installation target unit while catching the frame and the cover base, in which
the cover hold down member is placed on the cover such that a length from the receiving portion to the hold down portion is adjustable.

The cover base may extend so as to have a shape of a rectangular tube or a rectangular prism,
the cover hold down member may be placed on the cover so as to be pivotable with an axis parallel to an extension direction in which the cover base extends as a central axis, and
the length from the receiving portion to the hold down portion may be adjustable with a pivotal movement of the cover hold down member with respect to the cover.

The cover base may have a groove extending in the extension direction, and
the cover hold down member may have a pivot point portion pivotally fitted in the groove.

The cover hold down member may include:
a first portion that is plate-shaped, has the pivot point portion at an end thereof closer to the outside with respect to the inside-outside direction, and has a hole for insertion of the first fastener,
a second portion that is plate-shaped and has the hold down portion at an end thereof closer to the inside with respect to the inside-outside direction, and
a coupling portion that couples together the first portion and the second portion, and the second portion may incline with respect to the first portion.

The coupling portion may be plate-shaped and be coupled to the first portion so as to define an acute angle with the first portion when viewed in the extension direction, and
the second portion may be coupled to the coupling portion so as to define an acute angle with the coupling portion when viewed in the extension direction.

A portion at which the first portion and the coupling portion are coupled together may have a bent portion, and
in a state where the cover is attached to the installation target unit with the cover receiving member and the cover hold down member, the bent portion may contact the frame.

The cover attachment structure may include a critter guard fixed to the cover body.

The cover attachment structure may include a cover joint member that connects the cover to another cover.

The cover attachment structure may include a corner cover that connects an end of the cover and an end of another cover extending in a direction different from an extension direction in which the cover extends.

The end of the cover and the end of the other cover may form an external corner or an internal corner, and
the corner cover may connect a portion of the external corner or a portion of the internal corner.

The cover attachment structure may include a cap attached to the end of the cover.

The cover attachment structure may include a frame receiving member to fix the cover receiving member to the frame, the frame receiving member being attached to the cover receiving member, and
a second fastener for fixing the cover receiving member to the frame receiving member.

The present disclosure can provide a cover attachment structure that enables attachment of a cover to frames of an installation target unit that have various heights.

### BRIEF DESCRIPTION OF DRAWINGS

A more complete understanding of this application can be obtained when the following detailed description is considered in conjunction with the following drawings, in which:

FIG. 1 is a perspective view of a cover attachment structure according to an embodiment of the present disclosure;

FIG. 2 is a side view of the cover attachment structure according to the embodiment;

FIG. 3 is an exploded perspective view of the cover attachment structure according to the embodiment;

FIG. 4 is a first exploded side view of the cover attachment structure according to the embodiment;

FIG. 5 is a second exploded side view of the cover attachment structure according to the embodiment;

FIG. 6 is an exploded side view for explanation of a method for attaching the cover attachment structure according to the embodiment;

FIG. 7 is a first side view for explanation of effects produced by the cover attachment structure according to the embodiment;

FIG. 8 is a second side view for explanation of the effects produced by the cover attachment structure according to the embodiment;

FIG. 9 is a perspective view of a cover attachment structure according to Modified Example 1;

FIG. 10 is an exploded perspective view of the cover attachment structure according to Modified Example 1;

FIG. 11 is a side view of the cover attachment structure according to Modified Example 1;

FIG. 12 is a perspective view of a cover attachment structure according to Modified Example 2;

FIG. 13 is a side view of the cover attachment structure according to Modified Example 2;

FIG. 14 is a perspective view of a cover of a cover attachment structure according to Modified Example 3;

FIG. 15 is a plan view of the cover of the cover attachment structure according to Modified Example 3;

FIG. 16 is a perspective view of a cover of a cover attachment structure according to Modified Example 4;

FIG. 17 is a plan view of the cover of the cover attachment structure according to Modified Example 4;

FIG. 18 is a plan view of a cover of a cover attachment structure according to Modified Example 5; and

FIG. 19 is a perspective view of a cover of a cover attachment structure according to Modified Example 6.

### DETAILED DESCRIPTION OF THE INVENTION

Hereinafter, a cover attachment structure 1 according to an embodiment is described using the drawings. To facilitate comprehension, mutually orthogonal XYZ coordinates are set and appropriately referenced. In the drawings, the same or equivalent portions are assigned the same reference sign.

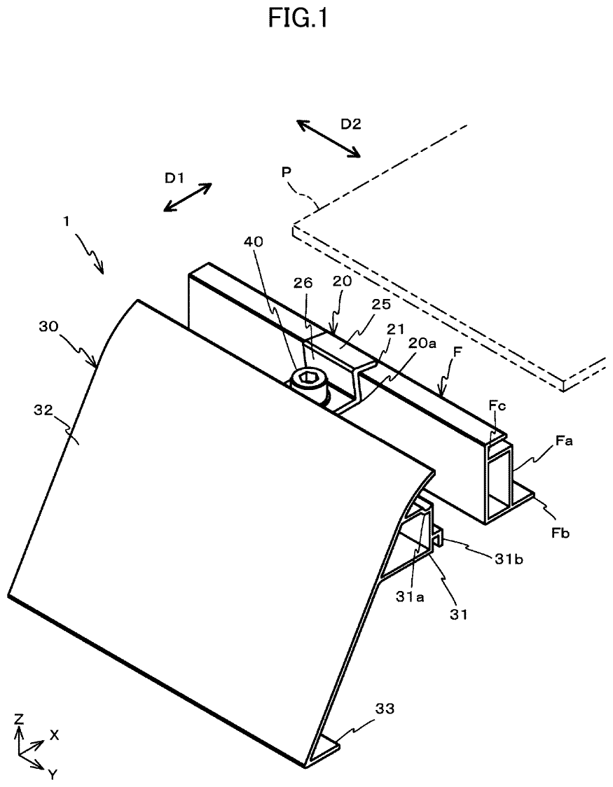

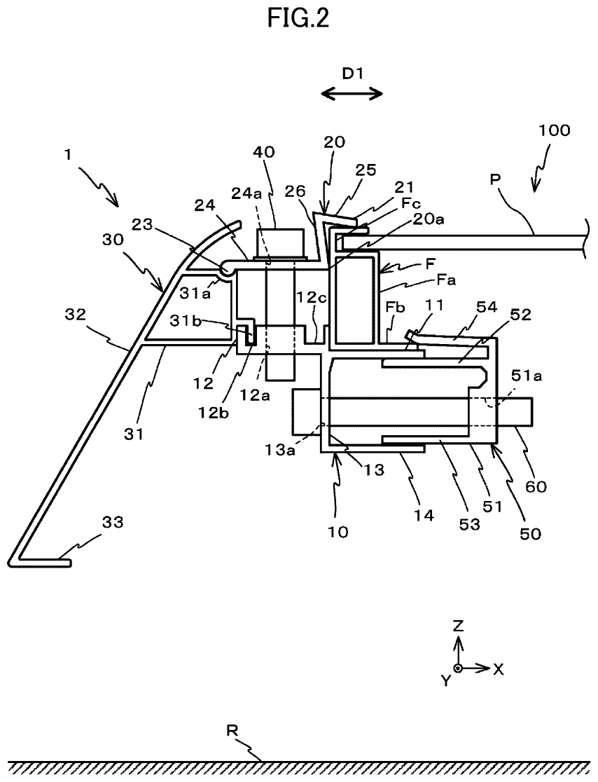

As illustrated in FIGS. 1 and 2, a solar panel unit 100 that is an installation target unit is, for example, mounted on an installation surface R, such as a roof of a building, with a mount. In the present embodiment, the building on which the solar panel unit 100 is mounted is a house that includes ridges and eaves of the roof. However, the present disclosure is not limited thereto. The solar panel unit 100 may be mounted in a location other than the installation surface R of the building. For example, the solar panel unit 100 may be mounted on the ground. The solar panel unit 100 includes a solar panel P and a frame F.

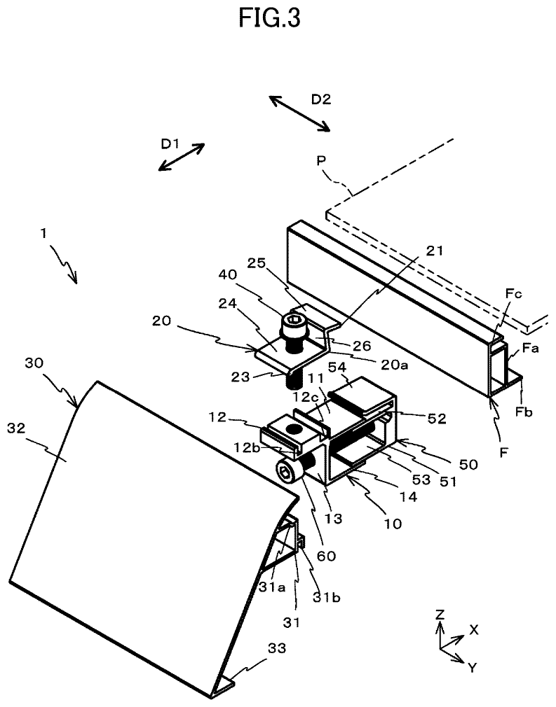

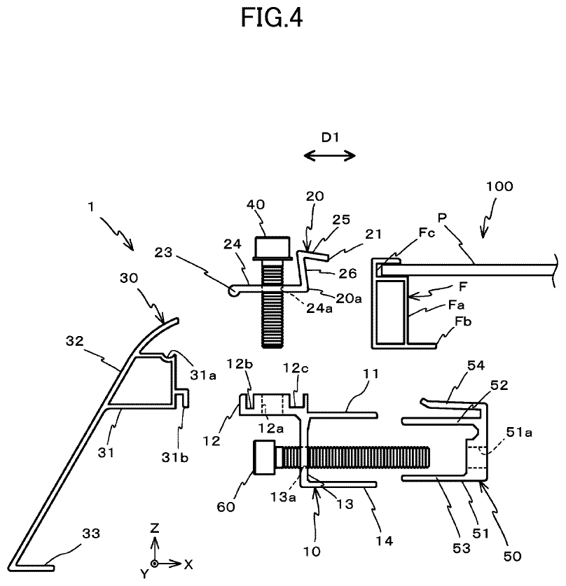

The solar panel P is a panel for solar photovoltaic power generation, and in the present embodiment, is plate-shaped, as illustrated in FIGS. 3 and 4.

The frame F is a frame body for supporting the solar panel P. The frame F has a body portion Fa having a shape of a rectangular tube extending in a Y-axis direction. The body portion Fa of the frame F has an XZ cross section having a rectangular shape with a longitudinal direction aligned with a Z-axis direction. The body portion Fa of the frame F has, at a lower part thereof, a protrusion Fb protruding in a positive X direction. Additionally, the body portion Fa of the frame F has, at an upper part thereof, a fitting portion Fc into which an end of the solar panel P is to be fitted.

The cover attachment structure 1 is an element for partially covering the solar panel unit 100 described above from the outside with the cover 30. The cover attachment structure 1 includes a cover receiving member 10, a cover hold down member 20, a cover 30, a first fastener 40, a frame receiving member 50, and a second fastener 60.

The cover receiving member 10 is a bracket that receives and supports the frame F of solar panel unit 100 and the cover 30 from below. The cover receiving member 10 includes a receiving portion 11, a receiving member main body 12, an extended portion 13, and a supporting portion 14.

The receiving portion 11 has a flat plate-like shape and protrudes from the receiving member main body 12 in the positive X direction. The frame F is placed on a flat plate-like upper surface of the receiving portion 11, that is, a surface on the positive Z side.

The receiving member main body 12 has a rectangular parallelepiped shape. The receiving member main body 12 has a screw hole 12a into which the first fastener 40 is screwed. The screw hole 12a has an inner surface formed into a female screw surface. The screw hole 12a penetrates in the Z-axis direction. The receiving member main body 12 has, in an upper surface of the rectangular parallelepiped shape, grooves 12b and 12c extending in the Y-axis direction. The groove 12b that is one of the two grooves 12b and 12c is located closer to the outside with respect to an inside-outside direction D1 than the other groove 12c, that is, located closer to a negative X side with respect to the other groove 12c. A part of the cover 30 is hooked in the groove 12b that is the groove closer to the outside.

The extended portion 13 has a flat plate-like shape and extends from the receiving member main body 12 in a negative Z direction. The extended portion 13 has a through hole 13a for insertion of the second fastener 60. The through hole 13a is a hole having an inner surface that is not formed into a female screw surface and the like. The through hole 13a penetrates in an X-axis direction.

The supporting portion 14 is plate-shaped and protrudes from a lower end of the extended portion 13, that is, an end at a negative Z side, in the positive X direction. The supporting portion 14 has a flat plate-like shape so as to be parallel to the flat plate-like shape of the receiving portion 11. The frame receiving member 50 is fitted between the supporting portion 14 and the receiving portion 11.

The cover hold down member 20 is a bracket that, with a hold down portion 21 and a pivot point portion 23, holds down the frame F of the solar panel unit 100 and the cover 30 from above. The cover hold down member 20 includes a first portion 24, a second portion 25, and a coupling portion 26, in addition to the hold down portion 21 and the pivot point portion 23.

The first portion 24 is plate-shaped. The first portion 24 has the pivot point portion 23 at an end thereof closer to the outside with respect to the inside-outside direction D1, that is, an end thereof closer to the negative X side. The first portion 24 has a through hole 24a for insertion of the second fastener 60. The through hole 24a is a hole having an inner surface that is not formed into a female screw surface and the like. The through hole 24a penetrates in the Z-axis direction.

The second portion 25 is plate-shaped and has a thickness equivalent to that of the first portion 24. The second portion 25 has the hold down portion 21 at an end thereof closer to the inside with respect to the inside-outside direction D1, that is, an end thereof closer to the positive X side. The second portion 25 is coupled to the coupling portion 26 so as to define an acute angle with the coupling portion 26 when viewed in the Y-axis direction.

Similarly to the first portion 24 and the second portion 25, the coupling portion 26 is plate-shaped and has a thickness equivalent to those of the first portion 24 and the second portion 25. The coupling portion 26 couples together the first portion 24 and the second portion 25. The coupling portion 26 is coupled to the first portion 24 so as to define an acute angle with the first portion 24 when viewed in the Y-axis direction. A portion at which the coupling portion 26 and the first portion 24 are coupled together has a bent portion 20a.

As illustrated in FIG. 2, in a state where the cover 30 is attached to the solar panel unit 100 with the cover receiving member 10 and the cover hold down member 20, the bent portion 20a contacts a side surface of the frame F on the negative X side.

As illustrated in FIGS. 3 and 4, the pivot point portion 23 has a rounded shape when viewed in the Y-axis direction.

In the cover hold down member 20 having the aforementioned configuration, the second portion 25 is coupled to the coupling portion 26 so as to define an acute angle with the coupling portion 26 when viewed in the Y-axis direction, and the coupling portion 26 is coupled to the first portion 24 so as to define an acute angle with the first portion 24 when viewed in the Y-axis direction. Due to this configuration, the cover hold down member 20 has a zigzag shape or a Z shape when viewed in the Y-axis direction.

The cover 30 is an element for partially covering the solar panel unit 100 from the outside and partially protecting the solar panel unit 100. The cover 30 is attached to the solar panel unit 100 with the cover receiving member 10 and the cover hold down member 20. In one example, the cover 30 is formed by extruding a metal. Specifically, in one example, the cover 30 is formed by extruding aluminum and, then, subjecting the surface thereof to black color alumite treatment, to cover the silver color that is the color of the aluminum itself. Although the cover 30 of the present embodiment partially covers the solar panel unit 100, the present disclosure is not limited thereto, and the cover 30 may cover an entirety of the solar panel unit 100. The cover 30 includes a cover base 31 and a cover body 32.

The cover base 31 has a shape of a rectangular tube extending in the Y-axis direction so as to have an upper surface, that is, a surface on the positive Z side. The cover base 31 has, in the upper surface at a portion closer to the inside, that is, a portion closer to the positive X side, a groove 31a extending in an extension direction D2, that is, in the Y-axis direction. The pivot point portion 23 of the cover hold down member 20 is fitted in the groove 31a so as to be pivotable around the Y-axis direction. The cover base 31 has an engaging portion 31b that is hooked the receiving member main body 12 by fitting into the groove 12b of the receiving member main body 12.

The cover body 32 has, at a portion closer to a lower end thereof, that is, at an end closer to the negative Z side, an inward protrusion 33 protruding inwardly from a bent portion.

The inward protrusion 33 is a part of the lower end that is bent inwardly. The inward protrusion 33 improves the strength of the lower end of the cover 30. In a case in which, for example, the cover 30 does not have the inward protrusion 33, the lower end of the cover 30 has a simple thin plate-like shape, consequently, is more likely to deform due to the application of a force from the outside. Thus, compared to a case in which the cover 30 does not have the inward protrusion 33, the present embodiment can prevent the lower end of the cover 30 from being more likely to deform due to the application of a force from the outside. Furthermore, the inclusion of the inward protrusion 33 in the cover 30 can enhance the flow of aluminum that is the material of the cover 30 when forming the cover 30 by extruding. For example, in a case in which the cover 30 does not have the inward protrusion 33, the flow of the aluminum that is the material of the cover 30 worsens when forming the cover 30 by extruding. Due to this, the aluminum may not flow uniformly to the lower end, and forming the lower end of the cover 30 into a desired shape may not be possible. In contrast, in the present embodiment, since the cover 30 has the inward protrusion 33, the effect of distributing the aluminum that is the material of the cover 30 up to the inward protrusion 33 that is the lower end of the cover 30 can be obtained. As a result, the present embodiment can enhance the manufacturing efficiency of the cover 30.

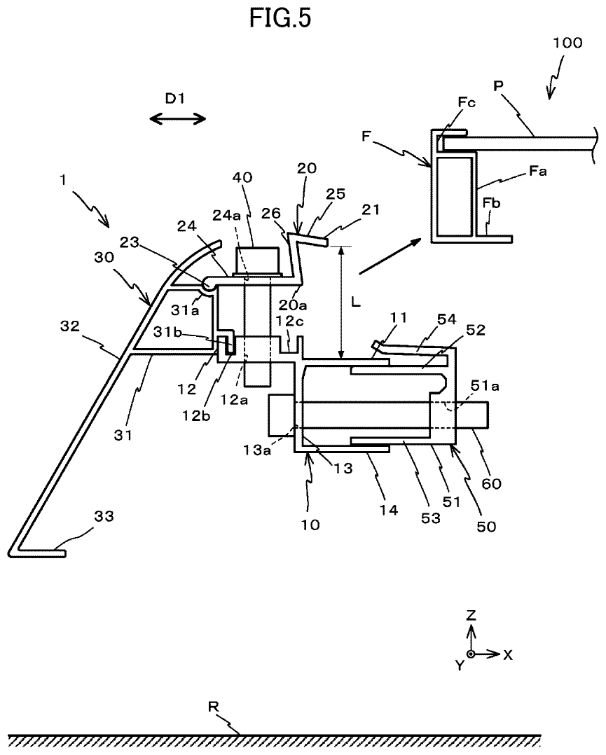

As illustrated in FIG. 5, by attaching the cover hold down member 20 to the cover 30 having the aforementioned configuration, the cover hold down member 20 is placed on the cover 30 such that a length L from the receiving portion 11 to the hold down portion 21 is adjustable.

As illustrated in FIGS. 3 and 4, the first fastener 40 includes, for example, a bolt or a screw. The first fastener 40 is inserted into the through hole 24a in the first portion 24 of the cover hold down member 20. Then the first fastener 40 inserted into the through hole 24a is screwed into the screw hole 12a in the receiving member main body 12 of the cover receiving member 10. This causes the first fastener 40 to fix the cover receiving member 10 and the cover hold down member 20 to the solar panel unit 100 while catching the frame F of the solar panel unit 100 and the cover base 31 of the cover 30.

The frame receiving member 50 is attached to the cover receiving member 10 and is used for stably fixing the frame F to the cover receiving member 10. The frame receiving member 50 includes a frame receiving member body 51, protrusions 52 and 53, and a frame hold down portion 54.

The frame receiving member body 51 has a screw hole 51a into which the second fastener 60 is screwed. The screw hole 51a has an inner surface formed into a female screw surface. The screw hole 51a penetrates in the X-axis direction.

The protrusions 52 and 53 are plate-shaped. The protrusions 52 and 53 protrude in the negative X direction from the vicinity of an upper end and the vicinity of a lower end of the frame receiving member body 51, respectively.

The frame hold down portion 54 protrudes in the negative X direction from the upper end of the frame receiving member body 51 above the protrusion 52. The frame hold down portion 54 sandwiches the plate-shaped receiving portion 11 and the protrusion Fb of the frame F between an upper surface of the protrusion 52. Due to this configuration, the frame receiving member 50 stabilizes the fixing of the frame F of the solar panel unit 100 to the cover receiving member 10.

The second fastener 60 includes, for example, a bolt or a screw. The second fastener 60 is inserted into the through hole 13a in the extended portion 13 of the cover receiving member 10. Then the second fastener 60 inserted into the through hole 13a is screwed into the screw hole 51a in the frame receiving member body 51 of the frame receiving member 50. This causes the second fastener 60 to fix the frame receiving member 50 to the cover receiving member 10.

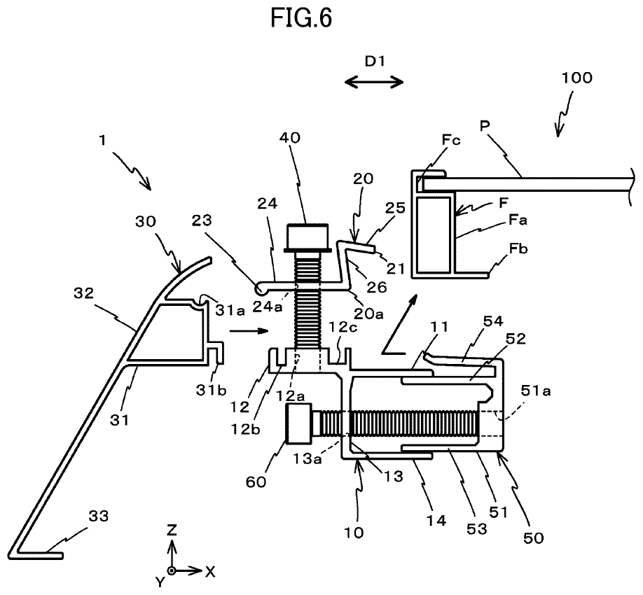

Next, a method for attaching the cover attachment structure 1 to the solar panel unit 100 is described using FIG. 6.

First, a worker prepares the cover receiving member 10 and the frame receiving member 50 assembled with the second fastener 60 as illustrated in FIG. 6. Then the cover hold down member 20 is temporary fixed to the cover receiving member 10 with the first fastener 40 to thereby form an assembly. Then this assembly is attached to the frame F of the solar panel unit 100. At this phase, the frame hold down portion 54 of the frame receiving member 50 supports the protrusion Fb of the frame F to achieve attachment that prevents detachment of the assembly from the frame F without fastening the first fastener 40. This improves the efficiency of the installation work of the cover attachment structure 1.

Next, the worker hooks the engaging portion 31b of the cover 30 into the groove 12b of the receiving portion 11. The engaging portion 31b hooked into the groove 12b achieves attachment that prevents detachment of the cover 30 from the frame F without fastening the first fastener 40. This improves the efficiency of the installation work of the cover attachment structure 1.

Next, the worker causes the first fastener 40 to be screwed into the screw hole 12a of the receiving portion 11 using a tool and the like. This causes the cover hold down member 20 to pivot with the pivot point portion 23 as a pivot point. As a result, the hold down portion 21 of the cover hold down member 20 holds the upper surface of the frame F, resulting in the solar panel unit 100 and the cover 30 fixed with the cover receiving member 10 and the cover hold down member 20. In the manner as described above, attachment of the cover attachment structure 1 to the solar panel unit 100 is completed.

As described above, in the cover attachment structure 1 according to the present embodiment, the cover hold down member 20 is placed on the cover 30 such that the length L from the receiving portion 11 of the cover receiving member 10 to the hold down portion 21 of the cover hold down member 20 is adjustable, as illustrated in FIGS. 1 and 5. This configuration allows the cover 30 to be attachable to the frame F with various heights.

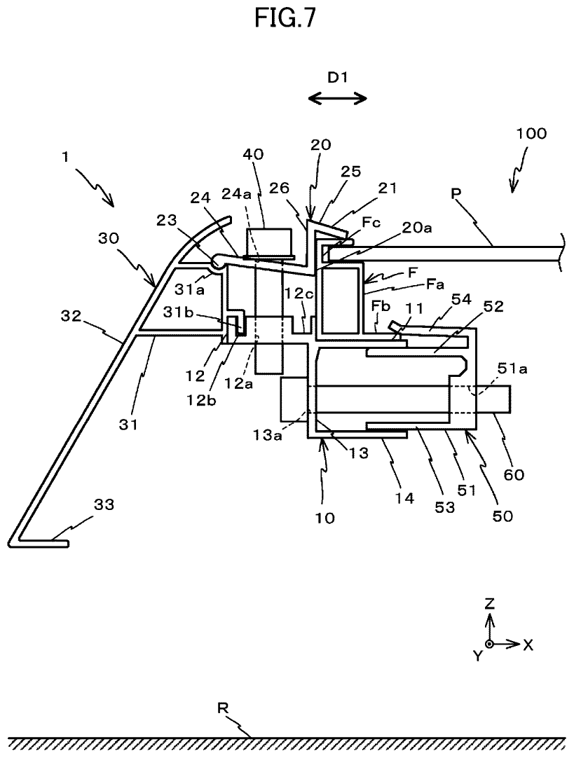

Specifically, as illustrated in FIG. 7, in the case of attaching the cover 30 to the frame F with a low height, that is, to the frame F with a short length in the Z-axis direction, causing to pivot with the pivot point portion 23 as a pivot point enables attaching the cover 30 to the frame F while shortening the length from the receiving portion 11 to the hold down portion 21. In this state, a surface of the coupling portion 26 of the cover hold down member 20 on the positive X side contacts a side surface of the frame F on the negative X side.

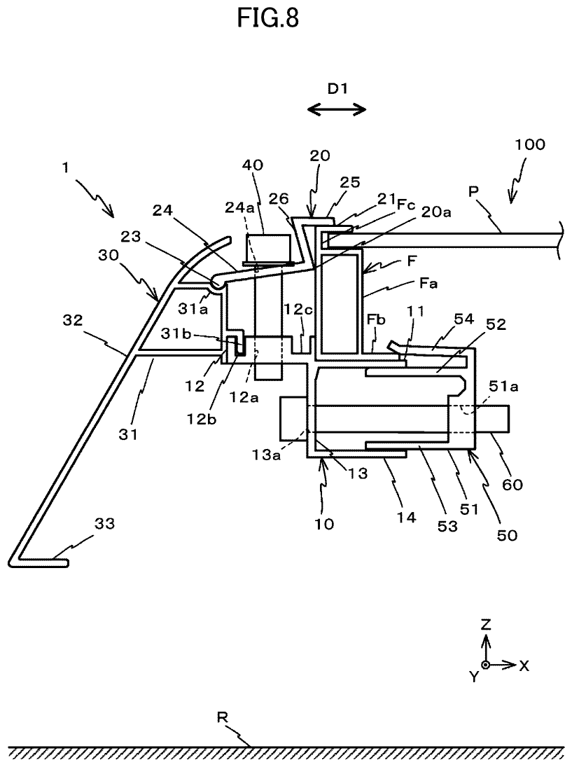

Additionally, as illustrated in FIG. 8, in the case of attaching the cover 30 to the frame F with a high height, that is, to the frame F with a long length in the Z-axis direction, causing to pivot with the pivot point portion 23 as a pivot point enables attaching the cover 30 to the frame F while extending the length from the receiving portion 11 to the hold down portion 21. In this state, a surface of the coupling portion 26 of the cover hold down member 20 on the positive X side does not contact the side surface of the frame F on the negative X side, whereas the bent portion 20a of the cover hold down member 20 contacts the side surface of the frame F on the negative X side.

Thus, according to the present embodiment, work efficiency of the cover attachment structure 1 for installment and detachment to and from the solar panel unit 100 can be improved. Furthermore, flexibility in attachment of the cover attachment structure 1 to the solar panel unit 100 can also be improved.

Furthermore, the cover attachment structure 1 is attachable to the solar panel unit 100 regardless of presence or absence of a mount for installation of the solar panel unit 100. This leads to improvement in the aesthetic of the solar panel unit 100 placed on the installation surface R and its surroundings.

An embodiment of the present disclosure is described above, but the present disclosure is not limited by the embodiment described above.

### Modified Example 1

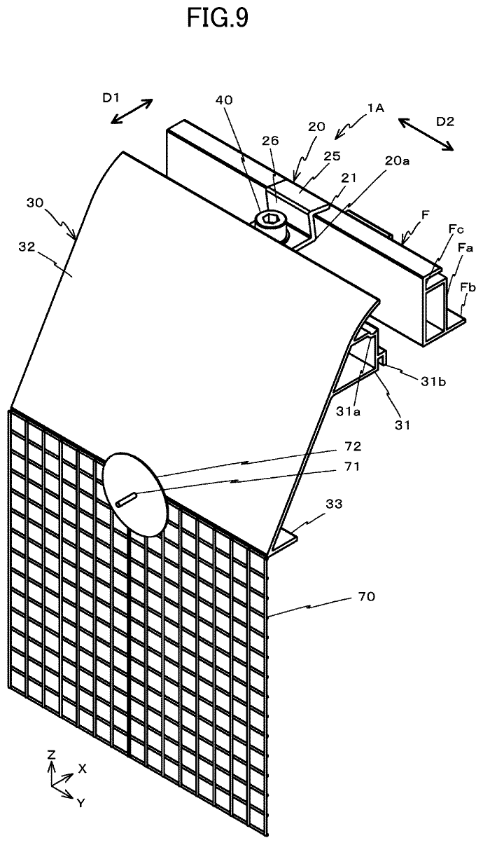

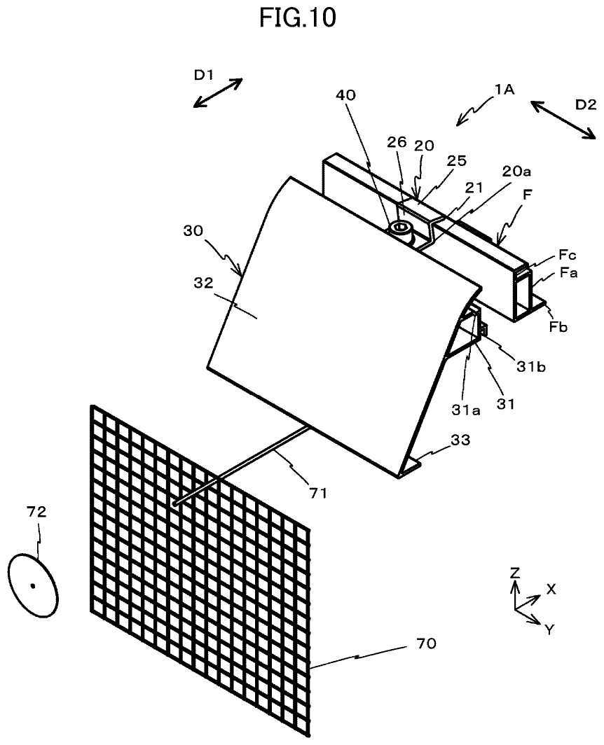

For example, although the present embodiment describes the cover attachment structure 1 that includes the cover receiving member 10, the cover hold down member 20, the cover 30, the first fastener 40, the frame receiving member 50, and the second fastener 60 as illustrated in FIGS. 3 and 4, this is not limiting. As in Modified Example 1 illustrated in FIGS. 9 and 10, a cover attachment structure 1A may include a critter guard 70 together with the aforementioned elements such as the cover receiving member 10.

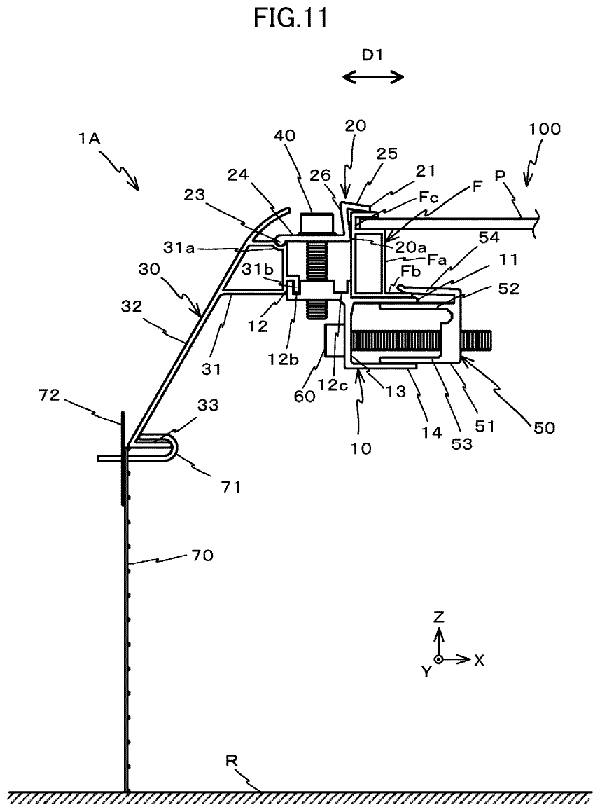

The critter guard 70 is fixed so as to hang from a lower end of the cover body 32 of the cover 30. The critter guard 70 is a metal mesh-like element for preventing nuisance animals, nuisance birds, and pest from entering the vicinity of the solar panel unit 100. However, the present disclosure is not limited thereto. The critter guard 70 may be formed from a material other than metal, or may be an element having a shape other than a mesh-like shape. In Modified Example 1, the critter guard 70 is hooked onto the inward protrusion 33 of the cover 30 by a hook 71 having a U-shaped tip. In one example, the hook 71 is formed by bending a metal wire material. However, the present disclosure is not limited thereto. The hook 71 may be made from a material other than a metal wire material. The critter guard 70 that is hooked onto the inward protrusion 33 of the cover 30 by the hook 71 is attached with a fastener clip 72 for preventing the critter guard 70 from being unhooked from the hook 71. The critter guard 70 is preferably placed such that the lower end thereof reaches the vicinity of the installation surface R of the solar panel unit 100 as illustrated in FIG. 11, in terms of preventing entry of nuisance animals, nuisance birds, and pest. Furthermore, using multiple critter guards 70 enables preventing entry of nuisance animals, nuisance birds, and pest in all of four directions, that is, the negative X direction, the positive X direction, the negative Y direction, and the positive Y direction. This configuration can prevent or suppress nuisance animals, nuisance birds, and pest from building nests inside, and also can prevent or suppress bite-through of cables of the solar panel P that are wired inside as illustrated in FIGS. 1 and 2.

### Modified Example 2

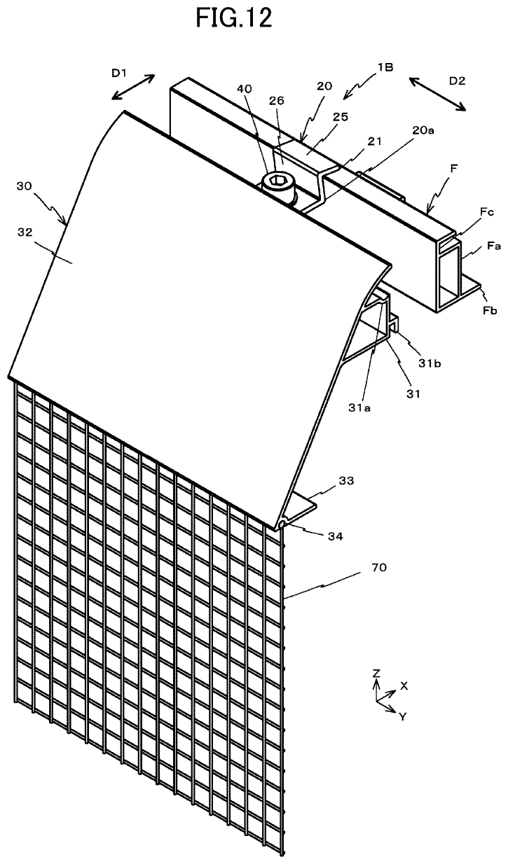

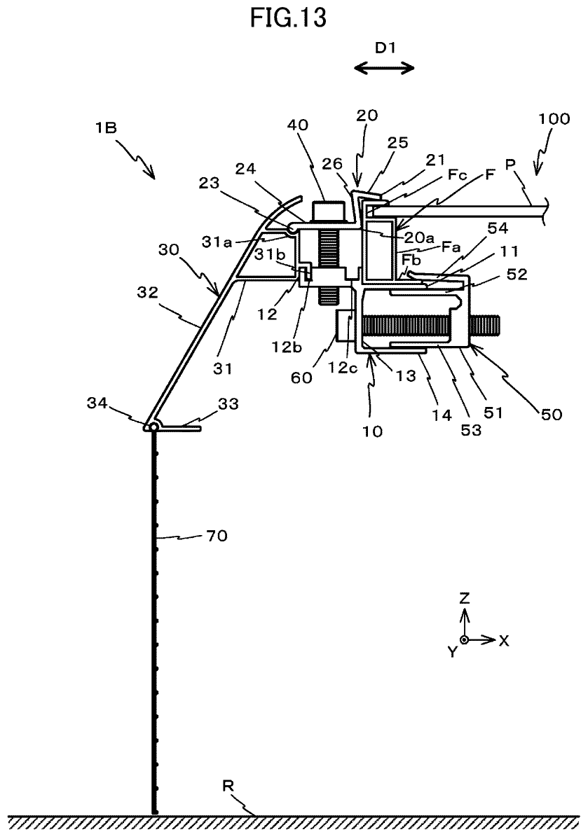

In Modified Example 1, the critter guard 70 is fixed to the cover 30 with the hook 71 and the fastener clip 72, as illustrated in FIG. 9. However, the present disclosure is not limited thereto. As in a cover attachment structure 1B according to Modified Example 2 that is illustrated in FIGS. 12 and 13, the critter guard 70 may be directly fixed to the cover 30. In this case, the cover body 32 of the cover 30 has, as the lower end thereof, an attached portion 34 that is groove-shaped. Furthermore, a metal wire with a round cross section is welded to an upper end of the critter guard 70. In Modified Example 2, fitting the metal wire at the upper end of the critter guard 70 to the attached portion 34 fixes the critter guard 70 to the cover 30.

### Modified Example 3

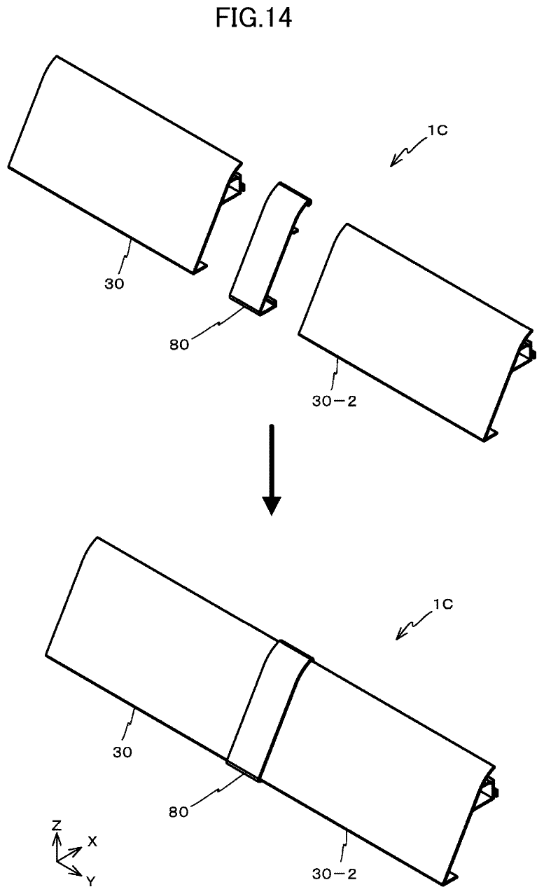

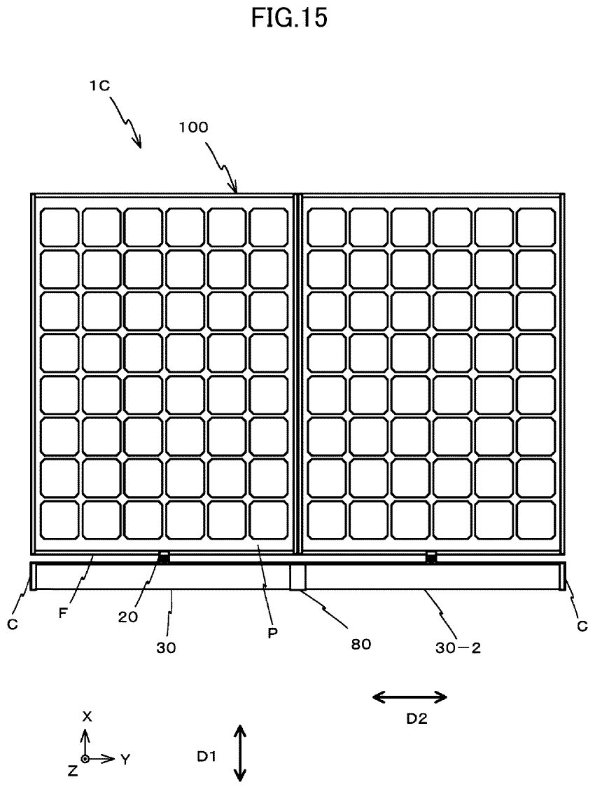

As in a cover attachment structure 1C according to Modified Example 3 that is illustrated in FIGS. 14 and 15, a cover joint member 80 may be included that connects the cover 30 to another cover 30-2. Modified Example 3 can also improve the aesthetic of the solar panel unit 100 placed on the installation surface R and its surroundings.

### Modified Example 4

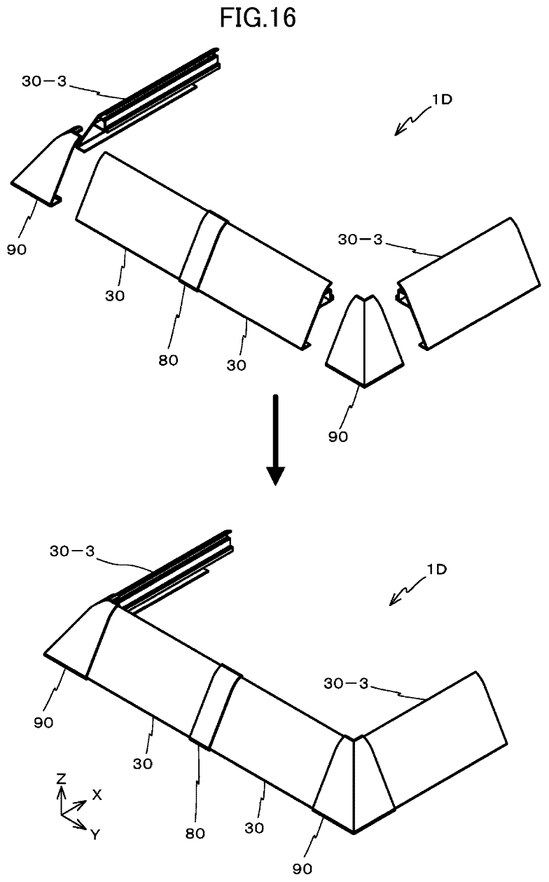

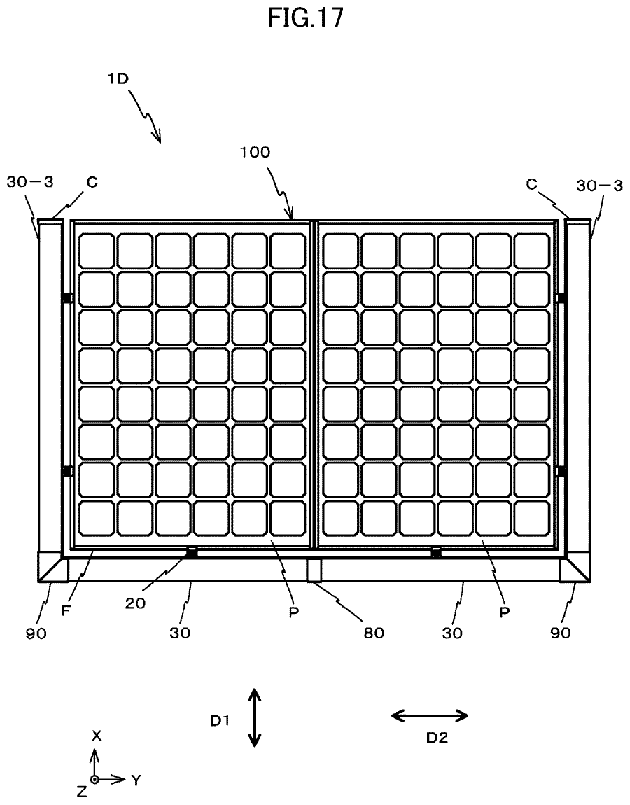

As in a cover attachment structure 1D according to Modified Example 4 that is illustrated in FIGS. 16 and 17, a corner cover 90 may be included that connects an end of the cover 30 and an end of another cover 30-3 that extends in a direction different from the extension direction D2, that is, the Y-axis direction, in which the cover 30 extends. Modified Example 4 can also improve the aesthetic of the solar panel unit 100 placed on the installation surface R and its surroundings. Furthermore, using multiple corner cover 90 enables the aesthetic of all of four corners.

### Modified Example 5

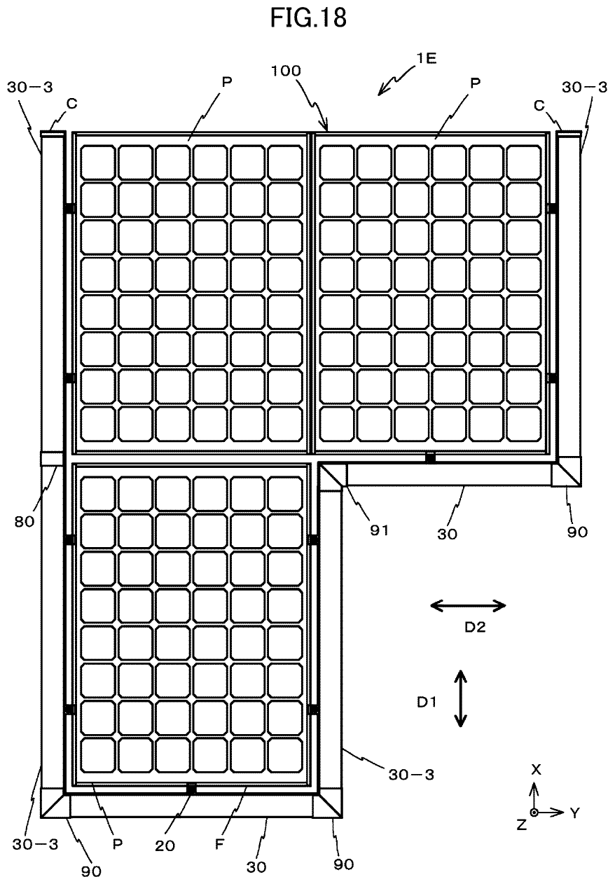

In Modified Example 4, as illustrated in FIGS. 16 and 17, the end of the cover 30 and the end of the other cover 30-3 are connected so as to form an external corner, and the corner cover 90 is a cover for an external corner. However, the present disclosure is not limited thereto. As in a cover attachment structure 1E that is illustrated in FIG. 18, a corner cover 91 for an internal corner may be used. In Modified Example 5, the end of the cover 30 and the end of the other cover 30-3 are connected so as to form an internal corner, and the corner cover 91 is a cover for connection at the internal corner. Appropriately using different corner covers 90 and 91 enables improvement in the aesthetic of the solar panel unit 100 placed on the installation surface R and its surroundings, while enabling improvement in flexibility of the combination of the covers 30 and 30-3.

Both in Modified Examples 4 and 5, an angle defined by the extension direction D2 of the cover 30, that is, the Y-axis direction, and the extension direction of the cover 30-3 is 90 degrees. However, the present disclosure is not limited thereto. The angle defined by the extension direction D2 of the cover 30, that is, the Y-axis direction, and the extension direction of the cover 30-3, may be an angle other than 90 degrees.

### Modified Example 6

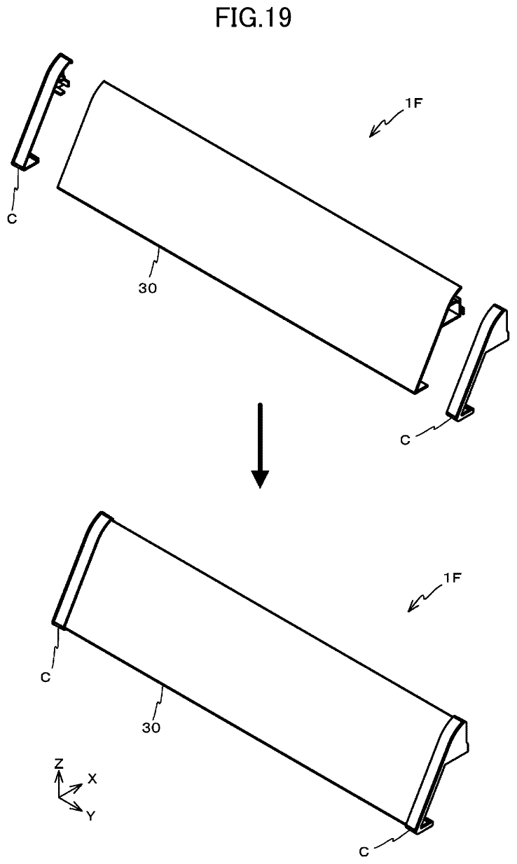

As in a cover attachment structure 1F according to Modified Example 6 that is illustrated in FIG. 19, a cap C may be included that is to be attached to an end of the cover 30. Modified Example 6 can also improve the aesthetic of the installation target placed on the installation surface R and its surroundings.

Furthermore, although the present embodiment describes the solar panel unit 100 as the installation target to which the cover attachment structure 1 is to be attached as illustrated in FIG. 1, the present disclosure is not limited thereto. The installation target to which the cover attachment structure 1 is to be attached may be other than the solar panel unit 100.

Furthermore, although the present embodiment describes the first fastener 40 as an element including a bolt or a screw as illustrated in FIGS. 3 and 4, the present disclosure is not limited thereto. The first fastener 40 may include an element other than a bolt and a screw. However, from the view point of the work efficiency for installment and detachment of the cover attachment structure 1 to and from the solar panel unit 100, an element that includes a bolt or a screw is preferable as the first fastener 40.

Furthermore, although the present embodiment describes the second fastener 60 as an element including a bolt or a screw as illustrated in FIGS. 3 and 4, the present disclosure is not limited thereto. The second fastener 60 may include an element other than a bolt and a screw. However, from the view point of the work efficiency for installment and detachment of the cover attachment structure 1 to and from the solar panel unit 100, an element that includes a bolt or a screw is preferable as the second fastener 60. Furthermore, the configuration may be used in which the second fastener 60 is omitted and the frame receiving member 50 is directly fixed to the cover receiving member 10.

Furthermore, although the cover hold down member 20 according to the present embodiment includes the second portion 25 having a plate-like shape inclined with respect to the first portion 24 having a plate-like shape, the present disclosure is not limited thereto. The second portion 25 may have a curved plate-like shape.

Although the cover hold down member 20 according to the present embodiment includes the coupling portion 26 coupled to the first portion 24 so as to define an acute angle with the first portion 24 when viewed in the extension direction D2, that is, the Y-axis direction, and the second portion 25 coupled to the coupling portion 26 so as to define an acute angle with the coupling portion 26 when viewed in the extension direction D2, that is, the Y-axis direction, the present disclosure is not limited thereto, and the cover hold down member 20 may have a shape different from the above shape.

Furthermore, although the present embodiment describes an example in which the installation surface R is a plane parallel to the XY plane as illustrated in FIG. 2, the present disclosure is not limited thereto. The installation surface R may be a slope inclined with respect to the XY plane. In this case, the solar panel unit 100 is placed on the installation surface R with the solar panel P thereof inclined, and the cover attachment structure 1 is attached to the solar panel unit 100 with inclination similarly to the solar panel P.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.
1, 1A, 1B, 1C, 1D, 1E, 1F Cover attachment structure
10 Cover receiving member
11 Receiving portion
12 Receiving member main body
12a Screw hole
12b, 12c Groove
13 Extended portion
13a Through hole
14 Supporting portion
20 Cover hold down member
20a Bent portion
21 Hold down portion
23 Pivot point portion
24 First portion
24a Through hole
25 Second portion
26 Coupling portion
30, 30-2, 30-3 Cover
31 Cover base
31a Groove
31b Engaging portion
32 Cover body
33 Inward protrusion
34 Attached portion
40 First fastener
50 Frame receiving member
51 Frame receiving member body
51a Screw hole
52, 53 Protrusion
54 Frame hold down portion
60 Second fastener
70 Critter guard
71 Hook
72 Fastener clip
80 Cover joint member
90, 91 Corner cover
100 Solar panel unit
P Solar panel
F Frame
Fa Body portion
Fb Protrusion
Fc Fitting portion
C Cap
R Installation surface
D1 Inside-outside direction
D2 Extension direction
L Length (from receiving portion to hold down portion)

### INDUSTRIAL APPLICABILITY

The present disclosure is suitable for use as a cover attachment structure for attaching a cover to a solar panel unit that is mounted on a roof surface of a house and that is placed on a surface of the roof surface.

1. A cover attachment structure for partially covering, with a cover, from outside with respect to an inside-outside direction, an installation target unit including an installation target and a frame supporting the installation target, the cover attachment structure comprising:
a cover receiving member to receive, with a receiving portion included in the cover receiving member at an end thereof closer to inside with respect to the inside-outside direction, from below, the frame supporting the installation target;
a cover hold down member to hold down the frame from above with a hold down portion included in the cover hold down member at an end thereof closer to the inside with respect to the inside-outside direction;
the cover including a cover base and a cover body included in the cover base, the cover base being received by the cover receiving member from below and being held down from above by the cover hold down member, the cover being to be attached to the installation target unit with the cover receiving member and the cover hold down member; and
a first fastener to fix the cover receiving member and the cover hold down member to the installation target unit while catching the frame and the cover base, wherein
the cover hold down member is placed on the cover such that a length from the receiving portion to the hold down portion is adjustable.

2. The cover attachment structure according to claim 1, wherein
the cover base extends so as to have a shape of a rectangular tube or a rectangular prism,
the cover hold down member is placed on the cover so as to be pivotable with an axis parallel to an extension direction in which the cover base extends as a central axis, and
the length from the receiving portion to the hold down portion is adjustable with a pivotal movement of the cover hold down member with respect to the cover.

3. The cover attachment structure according to claim 2, wherein
the cover base has a groove extending in the extension direction, and
the cover hold down member has a pivot point portion pivotally fitted in the groove.

4. The cover attachment structure according to claim 3, wherein
the cover hold down member includes:
a first portion that is plate-shaped, has the pivot point portion at an end thereof closer to the outside with respect to the inside-outside direction, and has a hole for insertion of the first fastener,
a second portion that is plate-shaped and has the hold down portion at an end thereof closer to the inside with respect to the inside-outside direction, and
a coupling portion that couples together the first portion and the second portion, and
the second portion inclines with respect to the first portion.

5. The cover attachment structure according to claim 4, wherein
the coupling portion is plate-shaped and is coupled to the first portion so as to define an acute angle with the first portion when viewed in the extension direction, and
the second portion is coupled to the coupling portion so as to define an acute angle with the coupling portion when viewed in the extension direction.

6. The cover attachment structure according to claim 5, wherein
a portion at which the first portion and the coupling portion are coupled together has a bent portion, and
in a state where the cover is attached to the installation target unit with the cover receiving member and the cover hold down member, the bent portion contacts the frame.

7. The cover attachment structure according to claim 1, further comprising:
a critter guard fixed to the cover body.

8. The cover attachment structure according to claim 1, further comprising:
a cover joint member that connects the cover to another cover.

9. The cover attachment structure according to claim 1, further comprising:
a corner cover that connects an end of the cover and an end of another cover extending in a direction different from an extension direction in which the cover extends.

10. The cover attachment structure according to claim 9, wherein
the end of the cover and the end of the other cover form an external corner or an internal corner, and
the corner cover connects a portion of the external corner or a portion of the internal corner.

11. The cover attachment structure according to claim 1, further comprising:
a cap attached to the end of the cover.

12. The cover attachment structure according to claim 1, further comprising:
a frame receiving member to fix the cover receiving member to the frame, the frame receiving member being attached to the cover receiving member, and
a second fastener for fixing the cover receiving member to the frame receiving member.
